(19) United States
(12) Patent Application Publication
(10) Pub. No.: US 2024/0227550 A1
(43) Pub. Date: Jul. 11, 2024

(54) DRIVELINE ASSEMBLY FOR A UTILITY VEHICLE

(71) Applicant: Polaris Industries Inc., Medina, MN (US)

(72) Inventors: David A. Galsworthy, Wyoming, MN (US); Adrien O. Lechat, Blaine, MN (US); Gary A. Pinkley, Lino Lakes, MN (US); Aaron D. Deckard, Zionsville, IN (US)

(21) Appl. No.: 18/615,503

(22) Filed: Mar. 25, 2024

Related U.S. Application Data
(63) Continuation of application No. 17/679,252, filed on Feb. 24, 2022.
Application No. 17/679,252 is a continuation of application No. 16/238,991, filed on Jan. 3, 2019, now Pat. No. 11,285,807.
(60) Provisional application No. 62/613,796, filed on Jan. 5, 2018.

(51) Int. Cl. B60K 17/344; B60G 3/20; B60K 5/00; B60K 5/02; B60K 17/08; B60K 17/22; B60K 17/34

(52) U.S. Cl. CPC B60K 17/344; B60G 3/20; B60K 5/00; B60K 5/02; B60K 17/08; B60K 17/22; B60K 17/34; B60G 2300/07; B60K 2005/003

(57) ABSTRACT

A driveline assembly for a utility vehicle includes an engine, a transmission positioned forward of the engine, and a gearbox operably coupled to the transmission.

### CROSS-REFERENCE TO RELATED APPLICATIONS

The present application is a continuation of U.S. patent application Ser. No. 16/238,991, filed on Jan. 3, 2019 which claims the benefit of U.S. Provisional Patent Application Ser. No. 62/613,796, filed on Jan. 5, 2018, the complete disclosures of which are expressly incorporated by reference herein. The present application also is related to U.S. Provisional Patent Application Ser. No. 62/608,952, filed on Dec. 21, 2017, and U.S. Provisional Patent Application Ser. No. 62/615,142 filed on Jan. 9, 2018, the complete disclosures of which are expressly incorporated by reference herein.

### FIELD OF THE DISCLOSURE

The present application relates to a utility vehicle and, more particularly, a driveline assembly for a utility vehicle which includes an automated sequential transmission.

Various driveline embodiments for a vehicle may include an engine and a transmission operably coupled to the front and/or rear wheels to provide motive power to drive the vehicle. The engine may have a plurality of cylinders and is configured to provide a maximum horsepower based on the parameters and specifications of the vehicle. The engine is operably coupled to the transmission, which may be an automated or manual transmission. In one embodiment, the transmission may be an automated sequential transmission (“AST”) which is configured as a manual transmission that shifts between or changes gears through sensors, pneumatics, and/or actuators rather than a clutch pedal.

Space constraints on a vehicle, especially an off-road vehicle which may have maximum width and length requirements for trail compatibility, may make it difficult to package the driveline components on the vehicle in a manner that does not interfere with other vehicle components. As such, there is a need to provide a compact driveline arrangement with an engine and an AST on an off-road vehicle.

### SUMMARY OF THE DISCLOSURE

In one embodiment of the present disclosure, a driveline assembly for a utility vehicle comprises an engine, an automated sequential transmission positioned forward of the engine, and a gearbox operably coupled to the automated sequential transmission.

In another embodiment of the present disclosure, a utility vehicle comprises a plurality of ground-engaging members, a frame assembly supported by the plurality of ground-engaging members, and an operator area supported by the frame assembly. The operator area includes seating with a first seating portion for an operator and a second seating portion for a passenger. The utility vehicle further comprises a driveline assembly operably coupled to the plurality of ground-engaging members. The driveline assembly comprises an engine positioned rearward of the operator area, an automated sequential transmission operably coupled to the engine and positioned at least partially rearward of the operator area, and a gearbox operably coupled to the automated sequential transmission and positioned rearward of at least a portion of the seating.

In a further embodiment of the present disclosure, a utility vehicle comprises at least one front ground-engaging member, at least one rear ground-engaging member, a frame assembly supported by the at least one front ground-engaging member and the at least one rear ground-engaging member, and an operator area supported by the frame assembly and including seating with a first seating portion for an operator and a second seating portion for a passenger. The utility vehicle further comprises a rear suspension assembly operably coupled to the at least one rear ground-engaging member and including trailing arms operably coupled to the at least one rear ground-engaging member and the frame, a shock absorber operably coupled to each of the trailing arm, at least one radius rod operably coupled to the at least one rear ground-engaging member. The utility vehicle also comprises a driveline assembly operably coupled to the at least one front ground-engaging member and the at least one rear ground-engaging member. The driveline assembly comprises an engine positioned rearward of the operator area and positioned within a longitudinal envelope defined by the trailing arms. The driveline assembly also comprises an automated sequential transmission operably coupled to the engine and positioned at least partially rearward of the operator area. The automated sequential transmission is positioned at least partially within the longitudinal envelope defined by the trailing arms. The driveline assembly further comprises a gearbox operably coupled to the automated sequential transmission and positioned rearward of at least a portion of the seating.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, where:

FIG. 1 is a front left perspective view of a utility vehicle of the present disclosure;

FIG. 2A is a schematic view of a driveline assembly of the utility vehicle of FIG. 1 with a first embodiment of a transmission;

FIG. 2B is a schematic view of the driveline assembly of FIG. 2A with a second embodiment of the transmission;

FIG. 3 is a front left perspective view of the driveline assembly of FIG. 2B;

FIG. 4A is a front left perspective view of an engine, automated sequential transmission, and a gearbox of the driveline assembly of FIG. 3;

FIG. 4B is a front right perspective view of the engine, automated sequential transmission, and gearbox of the driveline assembly of FIG. 4A;

FIG. 5 is an exploded view of the engine, automated sequential transmission, and gearbox of the driveline assembly of FIG. 4A;

FIG. 6 is a top view of the driveline assembly of FIG. 3 supported on a frame assembly of the utility vehicle of FIG. 1 and positioned relative to a rear suspension assembly of the utility vehicle of FIG. 1;

FIG. 7 is a rear right perspective view of a rear portion of the engine of FIG. 4A supported on the frame assembly of FIG. 6;

FIG. 8 is a front view of the engine, automated sequential transmission, and gearbox of the driveline assembly of FIG. 4A positioned relative to seating for the utility vehicle of FIG. 1; and

FIG. 9 is a top view of the engine, automated sequential transmission, and gearbox of the driveline assembly of FIG. 4A positioned relative to the seating of FIG. 8.

Corresponding reference characters indicate corresponding parts throughout the several views. Although the drawings represent embodiments of the present invention, the drawings are not necessarily to scale and certain features may be exaggerated in order to better illustrate and explain the present invention.

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings. While the present disclosure is primarily directed to a utility vehicle, it should be understood that the features disclosed herein may have application to other types of vehicles such as other all-terrain vehicles, motorcycles, snowmobiles, and golf carts.

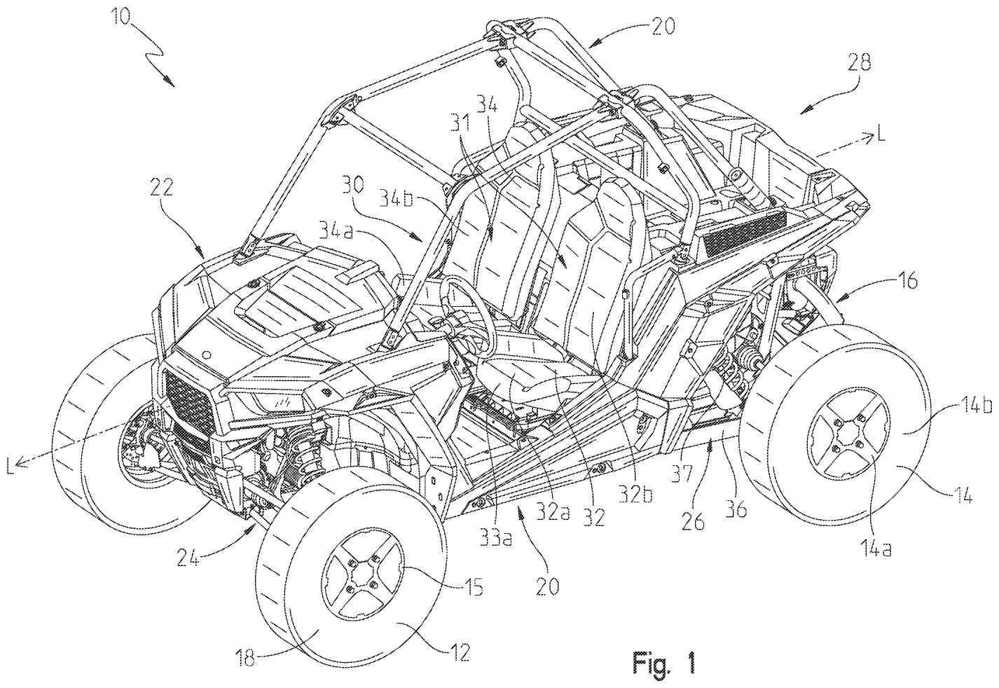

Referring to FIG. 1, an illustrative embodiment of a utility vehicle 10 is shown which is configured to traverse a variety of terrains, including mud, rocks, dirt, and other trail or off-road conditions. Vehicle 10 may be referred to as a utility vehicle (“UV”), an all-terrain vehicle (“ATV”), or a side-by-side vehicle (“SxS”) and is configured for travel over various terrains or surfaces. More particularly, vehicle 10 may be configured for military, industrial, agricultural, or recreational applications.

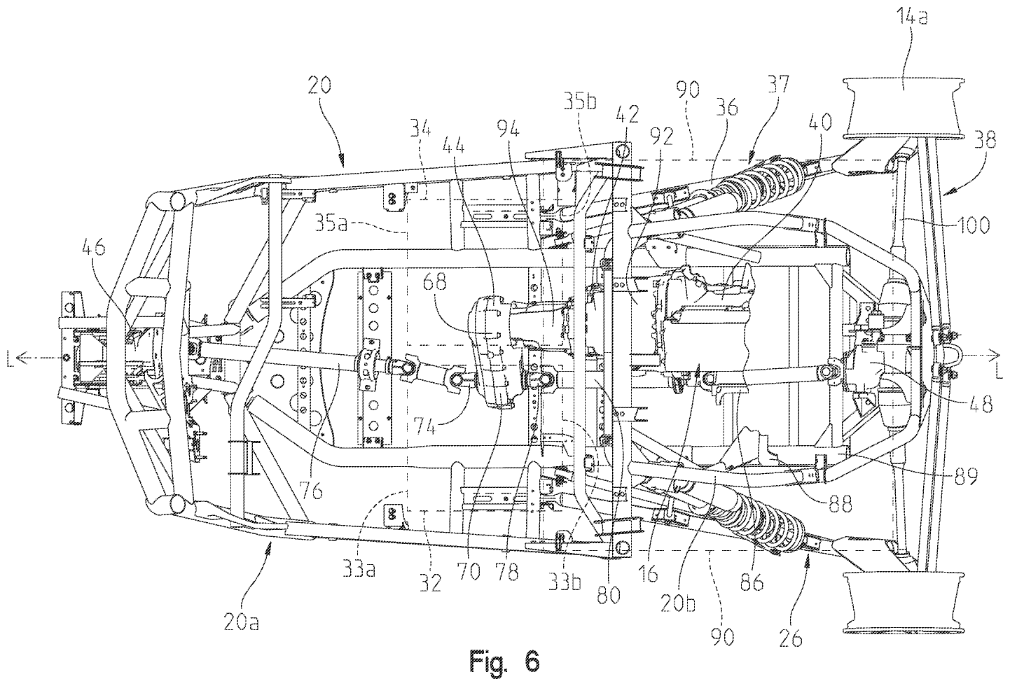

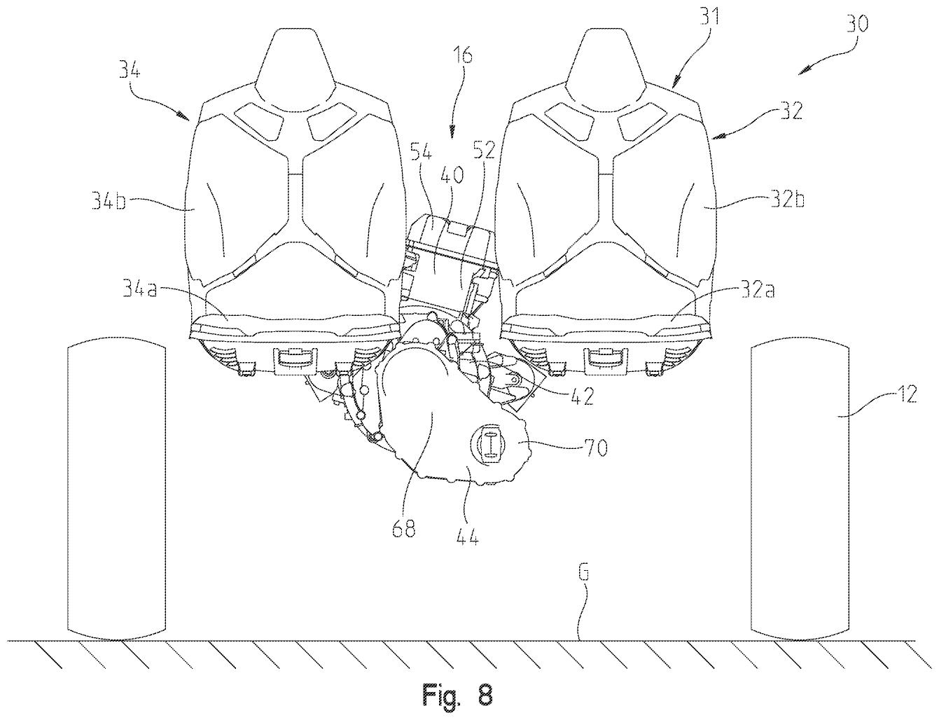

Vehicle 10 includes a plurality of ground-engaging members, including front ground-engaging members 12 and rear-ground engaging members 14, a powertrain or driveline assembly 16, a frame assembly 20, a plurality of body panels 22 coupled to frame assembly 20, a front suspension assembly 24 supported by a front portion of frame assembly 20, a rear suspension assembly 26 supported by a rear frame portion 20b of frame assembly 20, and a rear cargo area 28 supported by rear frame portion 20b of frame assembly 20. As shown in FIG. 1, vehicle 10 extends between front and rear ground-engaging members 12, 14 in a longitudinal direction along a longitudinal vehicle centerline L. More particularly, and as shown best in FIG. 6, frame assembly 20 includes a front frame portion 20a generally supported by front ground-engaging members 12 on a ground surface G (FIG. 8) and rear frame portion 20b generally supported by rear ground-engaging members 14 on ground surface G, and frame assembly 20 extends longitudinally between front and rear frame portions 20a, 20b along centerline L.

As shown in FIG. 1, front ground-engaging members 12 may include a wheel assembly 15 and a tire 18 extending radially about wheel assembly 15. Similarly, rear ground-engaging members 14 may include a wheel assembly 14a and a tire 14b extending radially about wheel assembly 14a. In one embodiment, one or more ground-engaging members 12, 14 may be replaced with tracks, such as the PROSPECTOR II tracks available from Polaris Industries, Inc. located at 2100 Highway 55 in Medina, Minn. 55340, or non-pneumatic tires as disclosed in any of U.S. Pat. Nos. 8,109,308, filed on Mar. 26, 2008; U.S. Pat. No. 8,176,957, filed on Jul. 20, 2009; and U.S. Pat. No. 9,108,470, filed on Nov. 17, 2010; and U.S. Patent Application Publication No. 2013/0240272, filed on Mar. 13, 2013, the complete disclosures of which are expressly incorporated by reference herein.

Referring still to FIG. 1, vehicle 10 includes an operator area 30 supported by frame assembly 20 and which includes seating 31 for at least an operator. One embodiment of vehicle 10 includes a first seating portion, illustratively an operator seat 32, and a second seating portion, illustratively a front passenger seat 34. More particularly, operator seat 32 and front passenger seat 34 are in a side-by-side arrangement, however, operator seat 32 and passenger seat 34 may be in a longitudinal arrangement or in any configuration of seats positioned adjacent each other or longitudinally spaced apart from each other. In one embodiment, vehicle 10 may include multiple passenger seats 34 positioned rearward of operator seat 32. Operator seat 32 includes a seat bottom 32a, illustratively a bucket seat, and a seat back 32b. Seat 32 has a forward-most extent 33a and a rearward-most extent 33b (FIG. 6). Similarly, front passenger seat 34 includes a seat bottom 34a, illustratively a bucket seat, and a seat back 34b. Seat 34 has a forward-most extent 35a and a rearward-most extent 35b (FIG. 6). Additional details of vehicle 10 may be disclosed in U.S. patent application Ser. No. 14/051,700, filed Oct. 11, 2013 (Attorney Docket No. PLR-15-25448.04P); U.S. patent application Ser. No. 14/477,589, filed Sep. 4, 2014 (Attorney Docket No. PLR-15-26062.03P); and U.S. patent application Ser. No. 14/577,908, filed Dec. 19, 2014 (Attorney Docket No. PLR-15-26601.01P); the complete disclosures of which are expressly incorporated by reference herein.

Referring to FIGS. 1 and 6, rear suspension assembly 26 is positioned rearward of operator area 30 and includes trailing arms 36 operably coupled to rear frame portion 20b and rear ground-engaging members 14, shock absorbers 37 operably coupled to rear frame portion 20b and trailing arms 36, and control arms or radius rods 38 operably coupled to rear frame portion 20b and rear ground-engaging members 14. Rear suspension assembly 26 also may include a torsion or sway bar (not shown) operably coupled to trailing arms 36. Additional details of rear suspension assembly 26 may be disclosed in U.S. Patent Application Ser. No. 62,608,952, filed on Dec. 21, 2017, and entitled “REAR SUSPENSION ASSEMBLY FOR A VEHICLE” (Attorney Docket No. PLR-15-28340.02P), the complete disclosure of which is expressly incorporated by reference herein.

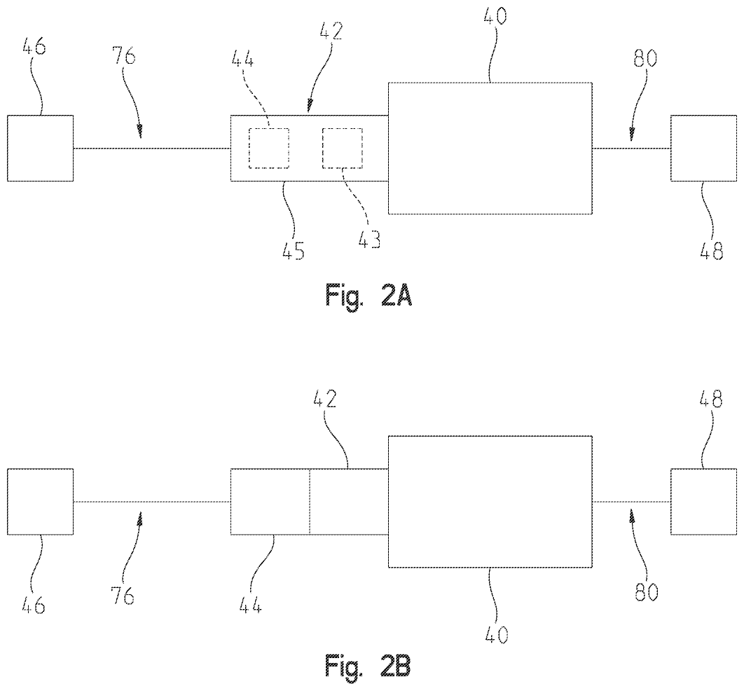

Referring to FIGS. 2A and 2B, driveline assembly 16 is disclosed. Driveline assembly 16 includes at least an engine 40, a transmission 42, a gearbox 44, a front final drive member 46, and a rear final drive member 48. Illustrative driveline assembly 16 is configured with engine 40 supported on rear frame portion 20b (FIG. 6), transmission 42 positioned longitudinally forward of engine 40, and gearbox 44 positioned longitudinally forward of transmission 42. As disclosed further herein, engine 40 is positioned longitudinally rearward of operator area 30 and, more particularly, is positioned longitudinally rearward of rearward-most extent 33b, 35b of seating 31. Transmission 42 may extend forwardly from engine 40 and may extend into a portion of operator area 30. Gearbox 44 also may be positioned within a portion of operator area 30.

Engine 40 may be an internal combustion engine or any other type of engine or motor configured to provide motive power for vehicle 10. Illustratively, engine 40 includes a crankcase or outer housing 50 configured to support at least a crankshaft (not shown) therein. Engine 40 also includes cylinders 52, illustratively four cylinder 52, coupled to crankcase 50 and extending upwardly therefrom. Cylinders 52 are coupled to cylinder heads 54. In one embodiment, cylinder 52 and cylinder heads 54 may be angled relative to a vertical axis (not shown) which perpendicularly intersects centerline L (FIG. 6). However, in other embodiments, cylinder 52 and cylinder heads 54 are aligned with the vertical axis. Engine 40 may be configured to operate with any type of fuel, such as gasoline, diesel, natural gas, etc.

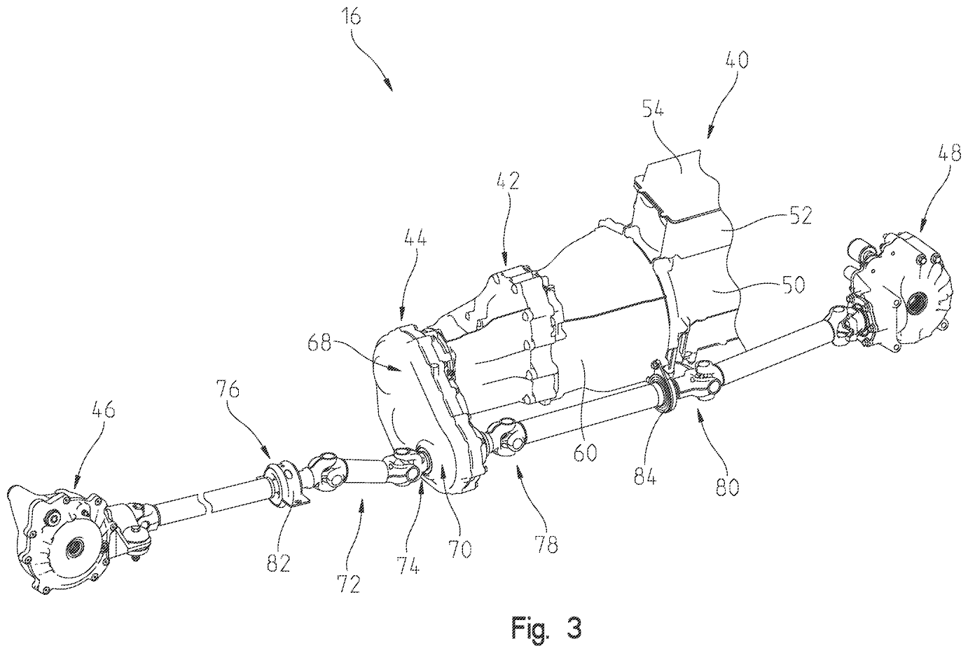

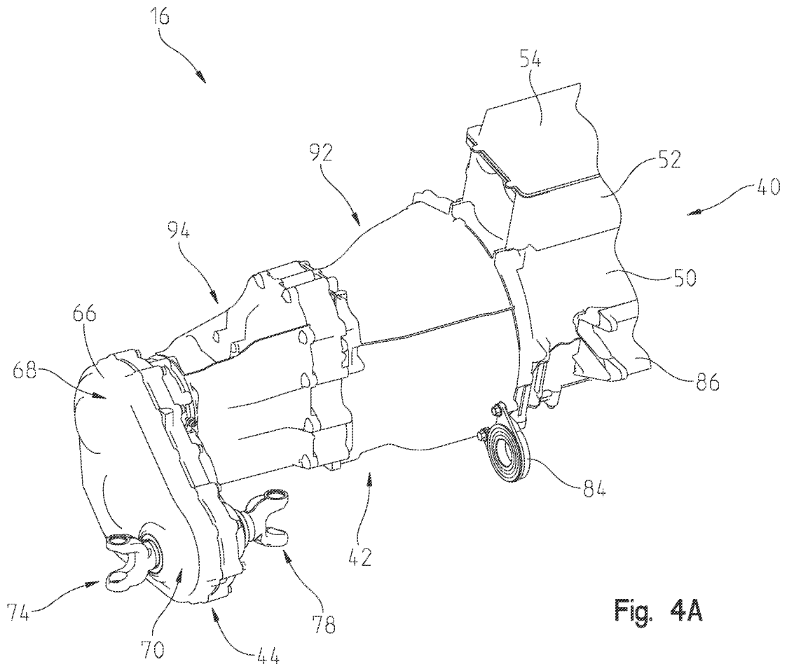

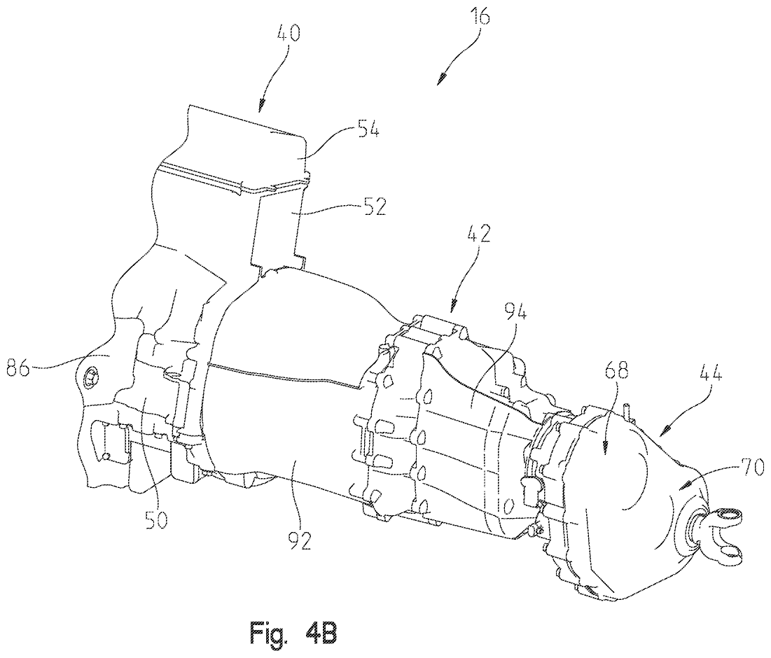

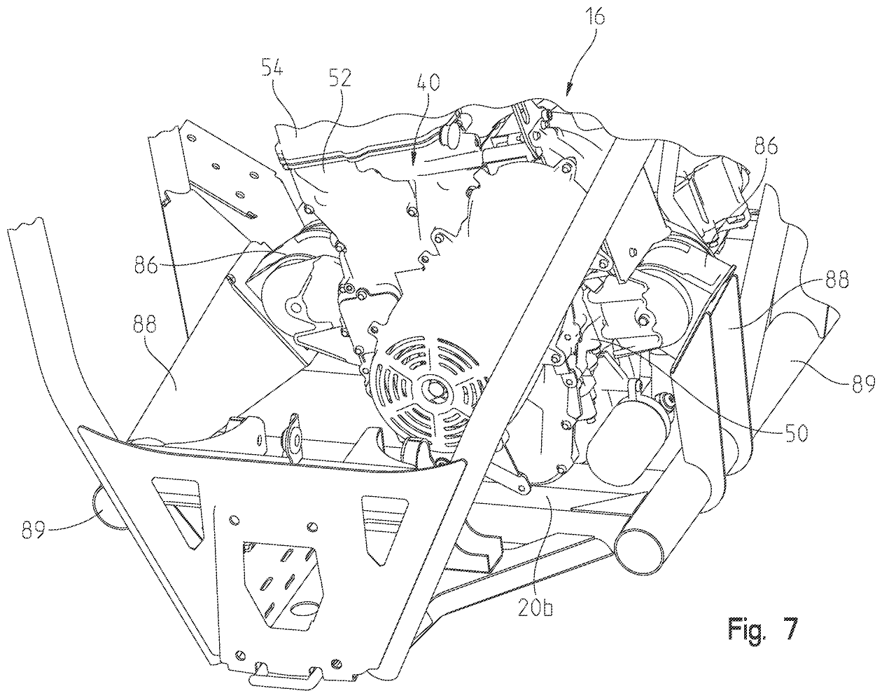

Engine 40 may be supported on rear frame portion 20b with engine mount assembly 86, as shown best in FIGS. 3-7. Engine mount assembly 86 may be removably coupled to crankcase 50 with mechanical fasteners or may be integrally formed with a portion of crankcase 50. Illustratively, and as shown best in FIGS. 6 and 7, engine mount assemblies 86 are configured to couple with frame arms 88 of rear frame portion 20b. Each of frame arms 88 are coupled to a longitudinally-extending frame member 89 of rear frame portion 20b and extend upwardly therefrom to couple with engine mount assembly 86. One or more of frame arms 88 may be angled relative to vertical in order to position engine 40 at a desired location on rear frame portion 20b.

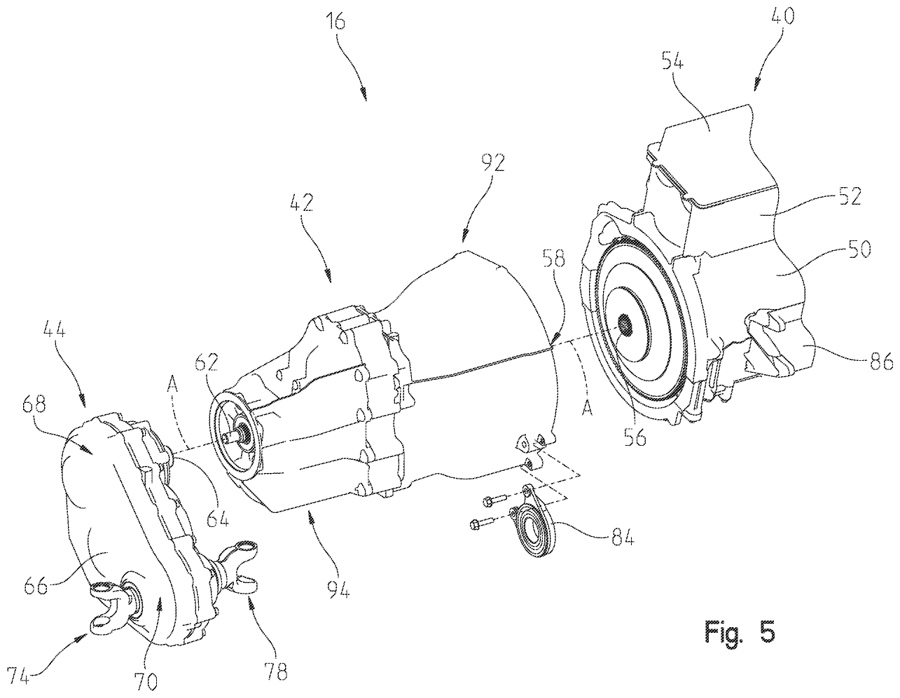

As shown in at least FIG. 5, engine 40 is configured with an output 56 which operably or drivingly couples engine 40 to transmission 42. More particularly, output 56 may be defined as a portion of the crankshaft (not shown) or a component operably coupled to the crankshaft such that rotational movement of the crankshaft is provided to transmission 42 through output 56. Output 56 of engine 40 is configured to align with an input 58 of transmission 42 to operably couple together engine 40 and transmission 42. In one embodiment, input 58 of transmission 42 may be a shaft or other member configured to receive rotational movement or output from output 56 of engine 40.

Referring still to FIGS. 2A-9, transmission 42 may be configured as an automated sequential transmission (“AST”) which includes a plurality of internal gears and at least one clutch (not shown) generally surrounded by an outer housing 60. In one embodiment, AST 42 also may include a reverse gear. AST 42 moves through gears in a sequential order but it is not necessary to engage intermediate gears before engaging the desired gear. For example, if the operator wishes to move from third gear to fifth gear, AST 42 will move through gears 3, 4, and 5 but it is not necessary for the operator to engage fourth gear before engaging fifth gear. In this way, a control system may open the clutch to allow rotation of the shift drum and move the dog rings from engaging third gear to fourth gear. With additional rotation of the shift drum, the dog rings move again from fourth gear to fifth gear. The clutch is then closed and torque is transmitted through fifth gear. In instances where a really fast shift is required, it is possible that the clutch will not be opened and, instead, the throttle opening may be changed to unload the dog rings and engage the next gear.

Because illustrative transmission 42 is configured as an AST, transmission 42 may have features of both an automatic transmission and a manual transmission. More particularly, transmission 42 may not automatically change gears, as would an automatic transmission, but does allow for a sequential manual gear change without the need to depress or otherwise actuate a clutch input (e.g., a clutch pedal, clutch lever). For example, transmission 42 may be operably coupled to sensors, actuators (e.g., an electric gear shift actuator, such as an electric motor), and/or any other device such that the clutch is clamped or engaged and gear changes may be electronically, hydraulically, pneumatically, or otherwise automated, rather than through a mechanical linkage. In one embodiment, the actuators may be electronically, hydraulically, or pneumatically-controlled to move between various gears of transmission 42 and may be controlled in response to sensor outputs rather than an operator input to a clutch member. With transmission 42 configured as an AST, vehicle 10 may be capable of various drive modes (e.g., rock-crawl mode) and may have the ability for various capabilities on certain terrain, such as holding the position of vehicle 10 when on an incline or hill in response to a throttle, clutch, and/or brake input. For example, the input may initiate a modulation of the throttle and clutch pressure to allow vehicle 10 to remain on an incline for a period of time.

To further facilitate different gear ratios or gear changes, driveline assembly 16 includes gearbox 44. Gearbox 44 also may be a shiftable mechanical range box or a transfer case and is configured to allow for a change between high and low gears and at least doubles the available gear ratios. Gearbox 44 also may include a reverse gear. In other embodiments, gearbox 44 may be controlled through any other means, such as electronics or pneumatics.

Referring to FIG. 2A, in one embodiment, gearbox 44 may be integral with AST 42 such that a gear set 43 of AST 42 and a gear set of gearbox 44 are positioned within a single housing 45. Alternatively, and referring to FIG. 2B, gearbox 44 may be separate from AST 42. Illustratively, as shown in FIG. 2B, gearbox 44 may be directly coupled to AST 42 but the gear sets thereof are each supported within separate housings.

With respect to the embodiment of FIG. 2B, and as shown best in FIG. 5, gearbox 44 is operably or drivingly coupled to transmission 42 through a connection between an output 62 of transmission 42 and an input 64 of gearbox 44. Illustratively, output 62 of transmission 42 may be an output shaft configured to provide rotational power to gearbox 44.

Referring still to FIG. 5, it may be appreciated that output 56 of engine 40 is longitudinally aligned with input 58 of transmission 42, input 58 is longitudinally aligned with output 62 of transmission 42, and output 62 is longitudinally aligned with input 64 of gearbox 44 such that outputs 56, 62 and inputs 58, 64 are all aligned along the same longitudinal axis A. In this way, engine 40 is longitudinally aligned with transmission 42 and a portion of gearbox 44.

As shown in FIGS. 3-9, gearbox 44 includes an outer housing 66 defining a first portion 68, which includes input 64, and a second portion 70. Illustratively, gearbox 44 extends laterally relative to centerline L such that first portion 68 is operably coupled to transmission 42 and is positioned on a first side (i.e., the right side) of centerline L and second portion 70 is positioned on a second side (i.e., the left side) of centerline L. As shown in FIGS. 3 and 6, second portion 70 is operably coupled to a prop shaft 72 such that internal gears (not shown) of gearbox 44 transmit movement of input 64 of first portion 68 to prop shaft 72 through gears in first and/or second portions 68, 70. Prop shaft 72 may be configured as a multi-piece prop shaft. More particularly, second portion 70 of gearbox 44 includes a first or forward output 74 operably coupled to a front prop shaft 76. Second portion 70 of gearbox 44 also includes a second or rearward output 78 operably coupled to a rear prop shaft 80. First and second outputs 74, 78 each may be defined as a joint, such as a portion of a U-joint.

As shown in FIGS. 3 and 6, front prop shaft 76 extends between gearbox 44 and front final drive member 46 and is operably coupled thereto to provide power to front final drive member 46 for driving front ground-engaging members 12. In this way, front prop shaft 76 extends forwardly from gearbox 44. Front prop shaft 76 may be supported on a portion of front frame portion 20a (FIG. 6) through a carrier bearing 82. Additionally, at least a portion of front prop shaft 76 may be angled relative to centerline L, as shown in FIG. 6. In one embodiment, front prop shaft 76 may be defined as a single shaft or may include a plurality of shafts operably coupled together.

Referring still to FIGS. 3 and 6, rear prop shaft 80 extends between gearbox 44 and rear final drive member 48 and is operably coupled thereto to provide power to rear final drive member 48 for driving rear ground-engaging members 14 with rear axles or half shafts 100. Rear final drive member 48 may be generally positioned along centerline L such that rear axles 100 have the same approximate lateral length between rear final drive member 48 and rear ground-engaging members 14.

Rear prop 80 may extend along a portion of rear frame portion 20b (FIG. 6) and may be supported by a carrier bearing 84 coupled to housing 60 of transmission 42. In this way, rear prop shaft 80 may not be coupled to frame assembly 20, but rather, may be coupled to transmission 42. Illustratively, rear prop shaft 80 extends rearwardly from gearbox 44 and is positioned laterally adjacent engine 40 and transmission 42. Rear prop shaft 80 may be configured to extend in a direction parallel to centerline L and may be positioned on the second side of centerline L, as shown in FIG. 6. In one embodiment, rear prop shaft 80 may be defined as a single shaft or may include a plurality of shafts operably coupled together.

Because vehicle 10 is configured for off-road applications, the width and wheel base of vehicle 10 may be reduced for trail compatibility. For example, the width of vehicle 10 may be approximately 50-65 inches and the wheel base of vehicle 10 may be approximately 70-110 inches. This compact size of vehicle 10 may necessitate the need for a particular arrangement or configuration of driveline assembly 16 on vehicle 10.

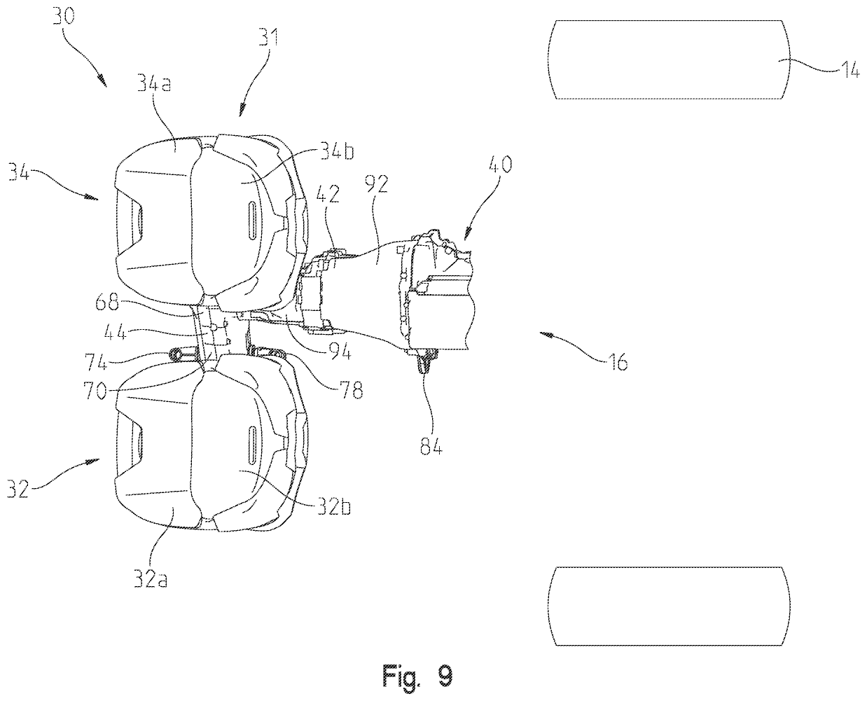

Illustratively, and referring to FIGS. 6-8, at least a portion of driveline assembly 16 is supported on rear frame portion 20b of frame assembly 20. More particularly, engine 40 is positioned entirely rearward of a rearward-most extent of operator area 30 such that the forward-most extent of engine 40 is rearward of rearward-most extent 33b, 35b of at least seats 32, 34. Additionally, engine 40 may be generally positioned to the first side (i.e., the right side) of centerline L such that the majority of engine 40 is positioned rearward of front passenger seat 34. However, as shown in FIG. 9, because cylinders 52 may be angled relative to vertical, at least a portion of cylinders 52 and cylinder heads 54 may be positioned laterally intermediate seats 32, 34. While cylinders 52 are at a longitudinal position rearward of the longitudinal position of seats 32, 34, the lateral position of cylinders 52 may be positioned along centerline L such that cylinders 52 are exposed between seats 32, 34 in the front view of FIG. 8.

Engine 40 also is positioned within an envelope defined by rear suspension assembly 26. More particularly, the longitudinal envelope of rear suspension assembly 26 may be defined by the forward-most extent of trailing arms 36 and the rearward-most extent of radius rods 38. Illustratively, the forward and aft extents of trailing arms 36 and the lateral width between trailing arms 36 together define a longitudinal envelope 90 thereof, and engine 40 is positioned entirely within longitudinal envelope 90 of trailing arms 36. In this way, engine 40 is positioned laterally intermediate trailing arms 36 and is positioned longitudinally within the longitudinal extent of trailing arms 36. As such, engine 40 is positioned outside of operator area 30 and does not interfere with components therein. Additionally, the front end portion of vehicle 10 may be made compact because engine 40 is not supported therein either.

As disclosed herein, transmission 42 is positioned longitudinally forward of engine 40 and, illustratively, is directly coupled to crankcase 50 with mechanical fasteners. In this way, transmission 42 is not spaced apart from engine 40 or laterally offset from engine 40 but, instead, is longitudinally aligned with engine 40. Transmission 42 is positioned rearward of a portion of operator arca 30 such that a rear portion 92 of transmission 42 is rearward of rearward-most extent 33b, 35b of at least seats 32, 34 and a forward portion 94 of transmission 42 extends into operator area 30. More particularly, rear portion 92 is positioned entirely rearward of rearward-most extent 33b, 35b of seating 31 and forward portion 94 may be positioned vertically under or below a portion of seat bottom 34a. In one embodiment, forward portion 94 of transmission 42 is positioned rearward of forward-most extent 35a of seat bottom 34a but is forward of rearward-most extent 35b of seat bottom 34a. Additionally, transmission 42 may be generally positioned to the first side (i.e., the right side) of centerline L such that at least the majority of transmission 42 is positioned rearward of front passenger seat 34.

Transmission 42 also is positioned partially within longitudinal envelope 90 of trailing arms 36. More particularly, as shown in FIG. 6, rear portion 92 of transmission 42 is positioned entirely within envelope 90 and forward portion 94 of transmission 42 is positioned partially within envelope 90. In this way, transmission 42 is at least partially positioned laterally intermediate trailing arms 36 and is partially positioned longitudinally within the longitudinal extent of trailing arms 36. As such, at least a portion of transmission 42 is positioned outside of operator area 30 and does not interfere with components therein. Additionally, the front end portion of vehicle 10 may be made compact because transmission 42 is not supported therein either.

Referring still to FIGS. 6-9, gearbox 44 is positioned longitudinally forward of transmission 42 and, illustratively, may be directly coupled to outer housing 60 of transmission 42 with mechanical fasteners. In this way, gearbox 44 is not spaced apart from transmission 42 is in a directly coupled relationship therewith. Additionally, at least first portion 68 of gearbox 44 is directly longitudinally aligned with transmission 42.

In order to accommodate gearbox 44 on vehicle 10, illustrative gearbox 44 is positioned within operator area 30 and, more particularly, is positioned vertically below or under a portion of seating 31 such that gearbox 44 and seating 31 are at least partially vertically overlapping. As shown in FIGS. 6, 8, and 9, first portion 68 of gearbox 44 may be positioned vertically below a portion of seat bottom 34a and second portion 70 of gearbox 44 may be positioned vertically below a portion of seat bottom 32a. In this way, and because first and second portions 68, 70 of gearbox 44 are integral with each other, gearbox 44 extends laterally across centerline L and between seats 32, 34 such that first portion 68 is positioned on the first side (i.e., the right side) of centerline L and second portion 70 is positioned on the second side (i.e., the left side) of centerline L. In one embodiment, gearbox 44 is positioned rearward of forward-most extent 33a, 35a of seat bottoms 32a, 34a but is forward of rearward-most extent 33b, 35b of seat bottoms 32a, 34a. Gearbox 44 also is positioned forward of envelope 90 of trailing arms 36.

Because second portion 70 of gearbox 44 is positioned on the second side of centerline L, rear prop shaft 80 also is positioned on the second side of centerline L. In this way, rear prop shaft 80 is laterally adjacent transmission 42 and engine 40 and is positioned on the opposite side of centerline L relative to a majority of at least engine 40 and transmission 42. Illustratively, rear prop shaft 80 may be parallel to centerline L. As shown in at least FIG. 6, engine 40 and transmission 42 are positioned laterally intermediate rear prop shaft 80 and trailing arm 36 on the right side of vehicle 10.

Additionally, because second portion 70 of gearbox 44 is positioned on the second side of centerline L, at least output 74 and a portion of front prop shaft 76 also are positioned on the second side of centerline L. Illustratively, as shown in FIG. 6, front prop shaft 76 may be angled relative to centerline L such that a rearward portion of front prop shaft 76 is positioned on the second side of centerline L but a forward portion of front prop shaft 76 may intersect centerline L to couple with front final drive member 46. Front final drive member 46 may be generally aligned with centerline L.

As disclosed herein, driveline assembly 16 is configured to extend from the front to the rear of vehicle 10 and components thereof are positioned on both the first and second sides of centerline L. As such, the configuration of driveline assembly 16, which includes engine supported on rear frame portion 20b, transmission 42 positioned forward of engine 40, rather to the side of engine 40, and gearbox 44 positioned forward of transmission 42, is accommodated on vehicle 10 without increasing the width or wheel base of vehicle 10. Additionally, the configuration of driveline assembly 16 allows for both front and rear ground-engaging members 12, 14 to be driven by engine 40.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1.-20. (canceled)

21. A utility vehicle, comprising:
a plurality of ground-engaging members;
a frame assembly supported on the plurality of ground-engaging members and extending along a longitudinal axis; and
a powertrain assembly supported by the frame assembly and comprising an engine and a transmission, the engine being separate from the transmission and longitudinally aligned with a portion of the transmission in a fore/aft direction of the utility vehicle, wherein;
an output of the engine is positioned to a first side of a vertical plane that is parallel to the longitudinal axis; and
an output of the transmission is positioned to a second side of the vertical plane.

22. The utility vehicle of claim 21, wherein at a least a portion of the engine is positioned to the first side of the longitudinal axis and at least a portion of the transmission is positioned to the first side of the longitudinal axis.

23. The utility vehicle of claim 22, wherein the powertrain assembly further comprises a prop shaft and the prop shaft is positioned to the second side of the longitudinal axis.

24. The utility vehicle of claim 23, wherein a vertical angle of the prop shaft is up to 20° relative to horizontal and a lateral angle of the prop shaft is up to 20° relative to the longitudinal axis.

25. The utility vehicle of claim 21, wherein the engine is longitudinally aligned with the transmission and rearward of the transmission.

26. The utility vehicle of claim 21, wherein a rearward extent of the transmission is coupled to a forward extent of the engine.

27. The utility vehicle of claim 21, further comprising a rear suspension assembly, the rear suspension assembly including upper arms operably coupled to at least a portion of the plurality of the ground engaging members, lower arms operably coupled to the portion of the plurality of ground engaging members, and trailing arms operably coupled to the frame assembly and the portion of the plurality of ground engaging members.

28. The utility vehicle of claim 27, further comprising an open-air cargo area.

29. The utility vehicle of claim 28, wherein the cargo area is positioned over the trailing arms, the upper arms, and the lower arms of the rear suspension assembly.

30. The utility vehicle of claim 28, further comprising an open-air operator area supported by the frame assembly and includes at least one seat comprising a seat back and a seat bottom.

31. The utility vehicle of claim 30, wherein the cargo area includes a cargo platform configured to support cargo thereon, and the cargo platform extends along a horizontal plane that intersects the seat back and is spaced apart from the seat bottom.

32. The utility vehicle of claim 30, wherein at least a portion of the engine is positioned rearward of the at least one seat.

33. The utility vehicle of claim 32, wherein the portion of the plurality of ground engaging members defines rear ground engaging members, and an envelope is defined between the open-air operator area and the rear ground engaging members, and the engine is positioned within the envelope.

34. The utility vehicle of claim 33, wherein the envelope extends from the cargo platform to an axis of rotation of the rear ground engaging members.

35. The utility vehicle of claim 21, wherein the transmission includes a housing and the engine is directly supported on the housing.

36. The utility vehicle of claim 35, wherein the powertrain assembly includes a front differential operably coupled to the transmission and a rear differential operably coupled to the transmission, and at least a portion of the engine is positioned below a portion of the rear differential.

37. The utility vehicle of claim 36, wherein the engine is positioned a first longitudinal distance from the front differential and a second longitudinal distance from the rear differential, and the second longitudinal distance is less than the first longitudinal distance.

38. The utility vehicle of claim 21, wherein the frame assembly comprises:
a plurality of longitudinally extending frame members including a driver side lower longitudinally extending frame member, a passenger side lower longitudinally extending frame member, a driver side upper longitudinally extending frame member, a passenger side upper longitudinally extending frame member;
a first plurality of upstanding frame members connecting the driver side lower longitudinally extending frame member and the driver side upper longitudinally extending frame member;
a second plurality of upstanding frame members connecting the passenger side lower longitudinally extending frame member and the passenger side upper longitudinally extending frame member, the engine and the transmission being positioned in a space defined by the driver side lower longitudinally extending frame member, the passenger side lower longitudinally extending frame member, the driver side upper longitudinally extending frame member, and the passenger side upper longitudinally extending frame member;
and the vehicle further comprising:
a rear suspension assembly, the rear suspension assembly including upper arms operably coupled to at least a portion of the plurality of the ground engaging members, lower arms operably coupled to the portion of the plurality of ground engaging members independent of the upper arms, and trailing arms operably coupled to the frame assembly and the portion of the plurality of ground engaging members independent of each of the upper arms and the lower arms;
an open-air cargo area positioned over the rear suspension assembly, the driver side upper longitudinally extending frame member, and the passenger side upper longitudinally extending frame member;
an open-air operator area supported by the frame assembly and includes at least one seat comprising a seat back and a seat bottom, the at least one seat being completely forward of the driver side upper longitudinally extending frame member and the passenger side upper longitudinally extending frame member.

39. A utility vehicle, comprising:
a plurality of ground-engaging members;
a frame assembly supported on the plurality of ground-engaging members and extending along a longitudinal axis;
a cargo area supported on the frame assembly; and
a powertrain assembly supported by the frame assembly and comprising an engine, a transmission, and a prop shaft operably coupled to the transmission and the plurality of ground-engaging members, the engine comprising a crankcase and a cylinder body positioned above the crankcase, and the cylinder body being angled relative to vertical toward a side of the utility vehicle in a direction substantially perpendicular to the longitudinal axis and positioned below a portion of the cargo area and over a portion of the prop shaft.

40. The utility vehicle of claim 39, wherein the prop shaft is angled vertically up to 20° relative to horizontal.

41. The utility vehicle of claim 39, wherein the crankcase is positioned on a first side of the longitudinal axis and the cylinder body is positioned on a second side of the longitudinal axis.

42. The utility vehicle of claim 41, wherein the prop shaft is positioned on the second side of the longitudinal axis.

43. The utility vehicle of claim 39, wherein the powertrain assembly further comprises a transmission positioned directly forward of the engine.
